(19) United States
(12) Patent Application Publication
(10) Pub. No.: US 2024/0266874 A1
(43) Pub. Date: Aug. 8, 2024

(54) WIRELESS CHARGER

(71) Applicant: Zehra Yildirim, ANKARA (TR)

(72) Inventor: Zehra Yildirim, ANKARA (TR)

(21) Appl. No.: 18/430,702

(22) Filed: Feb. 2, 2024

(30) Foreign Application Priority Data
Feb. 3, 2023 (WO) PCT/IB2023/050964

(51) Int. Cl. H02J 50/10; H02J 50/00; H02J 50/40; H02J 50/70; H02J 50/80; H02J 50/90

(52) U.S. Cl. CPC H02J 50/10; H02J 50/005; H02J 50/402; H02J 50/70; H02J 50/80; H02J 50/90

(57) ABSTRACT

A wireless charging device comprises a first transmission circuit, which has at least a first transmitter coil for transmitting wireless power, and a second transmission circuit, which has at least a second transmitter coil for transmitting wireless power.

### FIELD OF INVENTION

The field of the present invention relates generally to wireless charging devices for devices with rechargeable electric batteries.

### BACKGROUND OF THE INVENTION

Near-field wireless power transmission techniques transmission power over short distances through magnetic fields using an inductive or resonant connection between coils of wire or through electric fields using a capacitive connection between metal electrodes.

Inductive charging, also called wireless charging, is a type of wireless power transmission. It uses electromagnetic induction to power portable devices. The most common application is the Qi wireless charging standard for smartphones, smart watches and tablets. Inductive charging is also used in vehicles, power tools, electric toothbrushes and medical devices. Portable devices may be placed near a charging station or induction pad without the need for precise alignment or electrical contact with a docking station or outlet. Inductive charging systems may operate automatically without the need for plugging and unplugging, providing greater reliability.

Wireless charging devices include devices that use inductive coupling between two planar coils or devices that use capacitive coupling between metal electrodes to transmit electrical power from a power transmitter to a power receiver that may be connected to a power source. A port contains a physical interface that enables data communication and power transmission via cable between a circuit and external devices. Wireless charging involves the process of recharging or recharging a rechargeable or rechargeable battery. Transmission circuits generate magnetic fields for wireless charging through transmitter coils.

Devices for wirelessly charging electrically powered mobile devices such as devices and vehicles that contain rechargeable batteries are known. Known wireless charging devices convert the electricity that they receive via a power transmitter unit that may be connected to the power grid accordingly and transmit it wirelessly via the transmission circuit with a wireless charging transmitter coil to the mobile device with wireless charging receiver coil positioned next to the transmitter coil for wireless charging by inductive coupling method.

Electrical devices are known in which a wireless charging device is integrated, so that in these known devices the charging device is supplied with the electrical device from a common power line.

Since the size and capacity of the wireless charging transmitter coil are limited, wireless charging devices are known that use multiple wireless charging transmitter coils connected to an electrical transmission circuit although these are powered by a common power line and a common transformer. The capacity of the common power line and the common transformer is also limited.

There is a need for further development of charging devices to increase the effectiveness of wireless chargers and their operation.

### DESCRIPTION OF THE PRESENT INVENTION

The present invention provides a wireless charging device having a first transmission circuit that includes at least a first transmitter coil for transmitting wireless power and a second transmission circuit that includes at least a second transmitter coil for transmitting wireless power. The first transmission circuit is arranged so that it may be connected to a first power unit for power supply via a first power line to be powered by the first power unit, and the second transmission circuit is arranged to be connected to a second power unit via a second power line to be powered by the second power unit. The first power unit may include first power electronics, a first electrical power source or a first power connector in order to be coupled to the power supply. The second power unit may include second power electronics, a second electrical power source or a second power connector in order to be coupled to the power supply.

The first power line may include a first connector for coupling to the first power unit. The second power line may include a second connector for coupling to the second power unit. The first electrical connector and the second electrical connector may be arranged to be accessible to respective electrical cable connectors from outside the housing to be electrically connected to the first power unit and the second power unit, respectively. The first power electronics may include a first power converter. The second power electronics may include a second power converter. The first power converter may include a first rectifier. The second power converter may include a second rectifier.

The wireless charging device according to the invention may further comprise the first power line or the first power unit. The wireless charging device according to the invention may further comprise the second power line or the second power unit.

The first transmitter coil and the second transmitter coil may be arranged between a cover structure and a common shield. The first transmitter coil and the second transmitter coil may be arranged to be supported by the common shield. The common shield may include a ferrite shield. The wireless charging device according to the invention may further include the cover structure and the common shield.

The first transmission circuit may include a first transmission circuit controller for controlling the power supply to the first transmitter coil. The second transmission circuit may include a second transmission circuit controller for controlling the power supply to the second transmitter coil.

The wireless charging device may include a control device arranged to control the first transmission circuit and the second transmission circuit, preferably by supplying power to the first transmission circuit and the second transmission circuit, respectively.

The wireless charging device may include a first electrical switch arranged to be controlled by the control device to close the second power line to enable power transmission and open to stop power transmission. The wireless charging device may include a second electrical switch arranged to be controlled by the control device to close the first power line to enable power transmission and open to stop power transmission.

The control device may be configured to close the first power line and the second power line to enable power transmission and open to stop power transmission, respectively.

The controller may be arranged to be powered by the first or second power unit via a controller power line.

The first power line and the second power line may each comprise a first plug and a second plug for connection to the first power unit or the second power unit.

The wireless charging device may include a first electrical transformer and a second electrical transformer for supplying electrical power to the first power line and the second power line, respectively.

The wireless charging device according to the present invention may include a detection unit arranged to detect a physical feature of the first transmission circuit and the second transmission circuit and the control device, respectively, and to provide detection data to the control device based on the detected physical feature.

The detection unit may comprise at least one sensor module or a measuring circuit to sample power transmission. The detection unit may include a power sensor, a current sensor and/or a temperature sensor.

According to the present invention, the control device may be adapted to turn on and off the first electrical switch to selectively electrically couple and disconnect the first power line and the second power line, respectively, based on detection data. According to the invention, the first electrical switch may be turned on by the control device when it is determined based on detection data that the current value of the current supplied to the first transmission circuit via the first power line exceeds a predetermined threshold current value. Accordingly, the first electrical switch may be turned off if the current value does not exceed the predetermined threshold current value.

According to the present invention, the control device may be configured to control the first power circuit and the second power circuit based on detection data.

According to the present invention, the first transmitter coil and the second transmitter coil may be arranged such that a first magnetic field generated by the first transmitter coil at least partially superimposes or substantially completely or congruently superimposes a second magnetic field generated by the second transmitter coil when the first transmitter coil and the second transmitter coil is supplied with power.

According to the present invention, the first transmitter coil may be arranged such that it at least partially superimposes the second transmitter coil or substantially completely or congruently superimposes it. The first transmitter coil and the second transmitter coil may be arranged axially substantially one on top of the other. The first transmitter coil and the second transmitter coil may be arranged axially substantially or at least partially one on top of the other. The first transmitter coil and the second transmitter coil may be arranged substantially coaxially. The first transmitter coil and the second transmitter coil may be arranged obliquely to one another so that their central axes run at an angle to one another.

According to the present invention, the first transmitter coil or the second transmitter coil may each be coupled to the first transmission circuit controller on a first carrier plate of the first transmission circuit or the second transmission circuit controller on a second carrier plate of the second transmission circuit via a first flexible or movable coil line or a second flexible or movable coil line, so that the first transmitter coil or the second transmitter coil may be arranged movably in order to be able to move with respect to one another. According to the present invention, the wireless charging device may include a housing that may support the first transmission circuit, the second transmission circuit, the control device and the cover structure. At least one of the first transmitter coil, the second transmitter coil and the control device may be mobile or arranged outside the housing accommodating at least one of the first transmission circuit, the second transmission circuit and the control device.

According to the present invention, the control device may be configured to dock a mobile device with a wireless power transmission device, wherein the detection unit operatively coupled to the control device is arranged to detect a power transmission between the wireless power transmission device and the wireless charging device, wherein the control device is designed to output feedback when a wireless power transmission takes place between the charging device and the wireless power transmission device, wherein the control device is further configured to update and output the feedback during power transmission between the wireless charging device and the wireless power transmission device based on at least a power transmission rate of the wireless power transmission for optimal alignment of the mobile device with respect to the wireless charging device.

The control device may further be configured to calculate a power transmission rate based on the detected power transmission and to update the feedback based on at least the power transmission rate and a reference power transmission rate for optimal alignment of the mobile device with respect to the charging device. The control device may further be designed to output a location information based on the power transmission rate and the reference power transmission rate, preferably wherein the location information includes information about the efficiency of the power transmission between the charging device and the power transmission device, so that the alignment of the mobile device with respect to the charging device may be optimized according to information from the location information.

The control device may further comprise an output device for outputting the feedback or location information, which preferably comprises a display device with a screen, wherein the control device may be designed to output the feedback or location information via the screen.

According to the present invention there is provided a computer program product comprising instructions which, when executed by a processor of the control device, cause the processor to perform the following steps:
detecting the power transmission,
receiving a signal sent by the detection unit regarding the detected power transmission,
generating a power transmission rate with respect to the detected power transmission using the signal received from the detection unit,
outputting feedback during power transmission based at least on the power transmission rate,
further recording the power transmission,
receiving the signal sent by the detection unit regarding the further detected power transmission,
generating a further power transmission rate with respect to the further detected power transmission using the signal received from the detection unit,
updating and outputting the feedback during power transmission based on at least the further power transmission rate.

Detecting the power transmission may comprise sampling the power transmission.

Computer program product may include a non-transitory computer-readable medium that stores a program with the instructions.

The electronic units and devices included in the assemblies and devices described in this specification may be suitably electrically and/or communicatively and/or operationally and/or functionally interconnected to perform the functions described. The control device of the wireless charging device arranged to control the first transmission circuit and the second transmission circuit may be omitted if necessary. Accordingly, the first transmission circuit and the second transmission circuit may each be controlled independently of one another by the first transmission circuit control and the second transmission circuit control. Alternatively, the first transmission circuit controller may include the controller of the wireless charging device.

The components such as populated boards (PCBA) of an electrically operated switch, a charging transmitter coil and a measuring circuit are known to those skilled in the art and are not described in more detail in this disclosure. A measuring circuit may also include further electronics such as measuring transducers, output amplifiers, A/D converters and/or bus coupling, etc.

The controller may include a suitable data processing device with analog/digital signal and power input and output ports, memory, and microprocessor(s), such as a programmable logic controller (PLC), microcontroller, microprocessor, computer, or hardwired device that performs operations based on hardwired logic of the device. These devices may be commercially available devices suitably programmed or instructed to perform operations described herein from the instructions described above. Additionally or alternatively, one or more of these devices may be hardwired with logic circuitry to perform these operations.

The first or second measuring circuit may have a measuring unit that is set up to convert analog signals into digital signals. Analog current and voltage signals may be converted into digital current and voltage signals accordingly. The measuring unit may also be arranged to filter and calculate electrical power and power data. The data may be processed in one or more processing units.

Further advantages of the present invention are defined in the appended claims.

### BRIEF DESCRIPTION OF THE DRAWINGS

The above-described and other purposes and features of the present invention will be better understood from the following detailed description of the preferred embodiments of the invention and the accompanying figures.

FIG. 1 schematically illustrates a wireless charging device according to a first exemplary embodiment of the invention;

FIG. 2 schematically illustrates a wireless charging device according to a second exemplary embodiment of the invention;

FIG. 3a shows a flowchart according to the first exemplary embodiment of the invention;

FIG. 3b shows a flowchart according to the second exemplary embodiment of the invention.

### DETAILED DESCRIPTION OF PREFERRED EMBODIMENTS OF THE INVENTION

Preferred exemplary embodiments of the present invention are described below with reference to the attached figures. Preferred embodiments of the present invention will be described below with reference to the accompanying drawings, in which the same reference numerals refer to the same features.

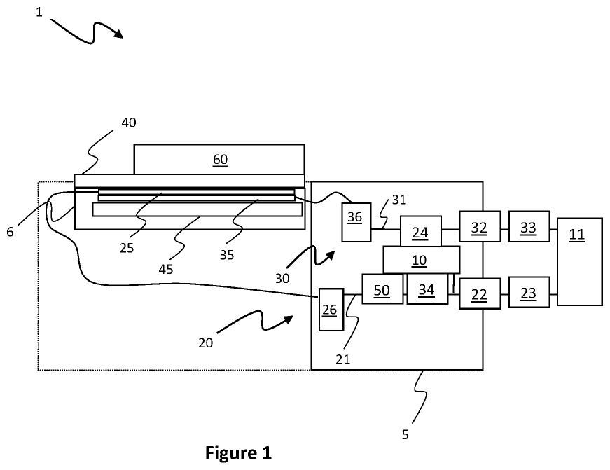

FIG. 1 shows a schematic representation of a wireless charging device 1 for wireless power transmission according to a first exemplary embodiment of the invention. The wireless charging device 1 comprises a first transmission circuit 20 with a first transmitter coil 25 and a second transmission circuit 30 with a second transmitter coil 35.

The first transmitter coil 25 is connected to a first transmission circuit controller 26 on a first carrier plate of the first transmission circuit 20 via a first flexible coil line. The second transmitter coil 35 is connected via a second flexible coil line to a second transmission circuit controller 36 on a second carrier plate of the second transmission circuit 30. The first transmission circuit controller 26 and the second transmission circuit controller 36 each serve to control the power supply to the first transmitter coil and the second transmitter coil.

The first transmission circuit 20 is connected to a first power unit 23 for power supply via a first power line 21 and the second transmission circuit 30 is connected to a second power unit 33 via a second power line 31. The first power unit 23 includes a first power adapter with first power electronics, which is coupled to the mains power supply 11. The second power unit 33 includes a second power adapter with second power electronics, which is coupled to the mains power supply 11.

The first power line 21 includes a first electrical connector 22 for coupling to the first power unit 23 in the form of a socket or a plug (e.g. USB socket or USB plug). The second power line 31 includes a second electrical connector 32 for coupling to the second power unit 33 in the form of a socket or a plug (e.g. USB socket or USB plug). The first electrical connector 22 and the second electrical connector 32 are arranged on the housing so that they can be electrically connected to the first power unit 23 and the second power unit 33 via respective electrical cables. The first power electronics 23 includes a first power converter. The second power electronics includes a second power converter. The first power converter includes a first rectifier. The second power converter includes a second rectifier.

The first transmitter coil 25 and the second transmitter coil 35 are arranged between a cover structure 40 and a common shield 45. The common shield first carries the first transmitter coil 25 and the second transmitter coil 35. The common shield includes a ferrite shield.

The wireless charging device 1 includes a control device 10 arranged to control the first transmission circuit 20 and the second transmission circuit 30, in which the first transmission circuit 20 and the second transmission circuit 30 are respectively controlled by the first power unit 23 and the second power unit 33 be supplied with electricity. For this purpose, the wireless charging device 1 comprises a first electrical switch 24, which is connected to the control device 10. The control device 10 may close the second power line 31 to enable power transmission and open it to stop power transmission by operating the first electrical switch 24. For this purpose, the wireless charging device 1 further comprises a second electrical switch 34, which is connected to the control device 10. The control device 10 may close the first power line 21 to enable power transmission and open it to stop power transmission by operating the second electrical switch 34.

The control device 10 is supplied with power from the first power unit 23 via a control device power line.

The first power unit 23 and the second power unit 33 are each connected via electrical coupling units in the form of a plug or a socket (e.g. USB plug or USB socket) to the respective connectors 22, 32 of the first power line 21 and the second power line 31 connected.

The detection unit 50 includes a measurement circuit arranged on the first power line 21 with a current sensor module to detect detection data regarding the current supplied to the first transmission circuit 20 and to transmit the detected detection data to the control device 10. The detection unit may further or alternatively comprise a power sensor and/or a temperature sensor. The control device 10 is adapted to selectively electrically close and open the second power line 31 based on the detection data by operating the first switch 24. According to the invention, the first electrical switch is turned on by the control device 10 when it is determined based on detection data that the current value of the current supplied to the first transmission circuit 20 via the first power line 21 exceeds a predetermined threshold current value.

According to the first exemplary embodiment, the first transmitter coil 25 and the second transmitter coil 35 are arranged substantially coaxially one on top of the other. When the first transmitter coil 25 and the second transmitter coil 35 are supplied with power, a first magnetic field generated by the first transmitter coil 25 substantially completely or congruently superimposes a second magnetic field generated by the second transmitter coil 35.

According to the first exemplary embodiment, the first transmitter coil 25 and the second transmitter coil 35 are each connected to the first transmission circuit controller 26 on a first carrier board of the first transmission circuit 20 and the second transmission circuit controller 36 on a second carrier board of the second transmission circuit 30 via a first flexible coil line and a second flexible coil line.

Thus, the first transmitter coil 25 and the second transmitter coil 35 may be moved with respect to each other. The wireless charging device 1 has a housing 5 which carries and accommodates the first transmission circuit 20, the second transmission circuit 30 and the control device. The first transmitter coil 25 and the second transmitter coil 35 are arranged outside the housing 5 in a charging housing 6 so that a first magnetic field generated by the first transmitter coil 25 substantially superimposes a second magnetic field generated by the second transmitter coil 35 when the first transmitter coil 25 and the second transmitter coil 35 is supplied with power. The cover structure 40 is arranged on the charging housing 6. Alternatively, the charging housing 6 may be omitted or formed integrally with the housing 5.

A mobile device 60 may be charged wirelessly via the transmitter coils 25, 35 if a receiver coil of the mobile device 60 is aligned with the transmitter coils 25, 35, i.e. is at least partially placed in the magnetic fields generated by the transmitter coils 25, 35.

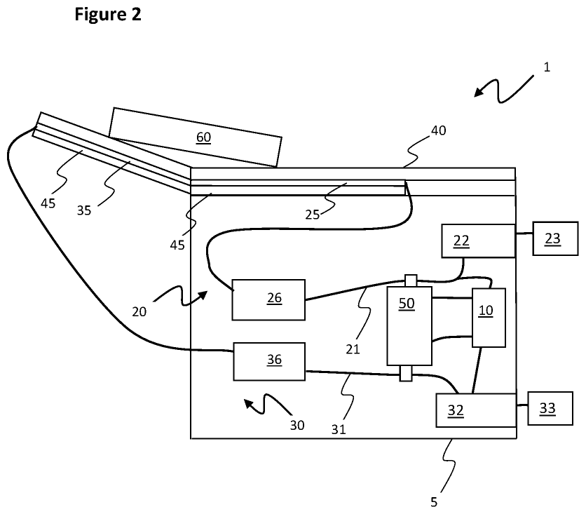

FIG. 2 shows a schematic representation of a second exemplary embodiment of the invention. The corresponding features of the second exemplary embodiment are given the same reference numerals and these features are not repeated in this description. Features different from the first embodiment are described below.

According to the second exemplary embodiment, a wireless charging device 1 for wireless power transmission comprises first and second transmitter coils 25, 35 arranged obliquely towards one another. The second transmitter coil 35 is arranged to be mobile or movable outside of a housing 5 accommodating a first transmission circuit 20, a second transmission circuit 30 and a control device 10, such that a first magnetic field generated by the first transmitter coil 25 at least partially superimposes a second magnetic field generated by the second transmitter coil 35 when the first transmitter coil 25 and the second transmitter coil 35 are supplied with power.

The detection unit 50 includes, in addition to the measuring circuit arranged on the first power line 21, a further measuring circuit arranged on the second power line 31, which has a current sensor module to acquire detection data regarding the current supplied to the second transmitting circuit 30, and to transmit the acquired detection data to the control device 10. The further detection unit may further or alternatively comprise a power sensor and/or a temperature sensor.

The control device 10 is additionally configured for docking a mobile device with a wireless power transmission device. The detection unit 50, which is operationally coupled to the control device 10, is arranged to detect the power transmission between the mobile device 60 and the wireless charging device 1.

The control device 10 is designed to output feedback when a wireless power transmission takes place between the charging device 1 and a wireless power transmission device of the mobile device 60. The control device 10 is further configured to update and output the feedback during power transmission between the wireless charging device 1 and the wireless power transmission device based at least on a power transmission rate of the power transmission for optimal alignment of the mobile device 60 with respect to the wireless charging device 1.

The control device 10 further comprises an output device (not shown) for outputting the feedback or location information, which comprises a display device with a screen, the control device 10 being designed to output the feedback or location information via the screen.

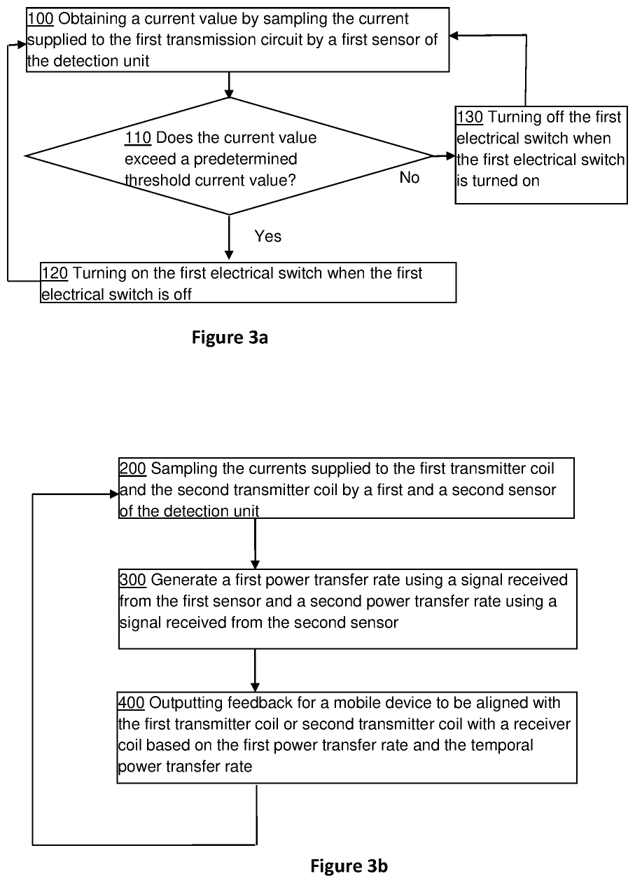

FIG. 3a shows schematically an operating method of the control device 10 according to the first exemplary embodiment. Accordingly, the control device 10 is configured to perform the following steps:
obtaining 100 a current value by sampling the current supplied to the first transmitting circuit 20 by a first sensor of the detection unit 50, determining 110 whether the current value exceeds a threshold current value, turning on 120 the first electrical switch 24 when the current value exceeds a threshold current value and when the first electrical switch 24 is turned off, turning off 130 the first electrical switch 24 when the current value does not exceed a threshold current value when the first electrical switch 24 is turned on.

FIG. 3b shows schematically an operating method of the control device 10 according to the second exemplary embodiment. Accordingly, the control device 10 is configured to perform the following steps:
sampling 200 of the currents supplied to the first transmitter coil and the second transmitter coil by a first and a second sensor of the detection unit, receiving signals sent by the detection unit regarding the sampled power transmission,
generating 300 a first power transmission rate using a signal received from the first sensor and a second power transmission rate using a signal received from the second sensor,
outputting 400 feedback for a mobile device with a receiver coil to be aligned with the first transmitter coil or second transmitter coil based on the first power transmission rate and the temporal power transmission rate, repeating steps 200 to 400 to update and output 400 feedback.

The above description is not limiting. According to the present invention, the charging transmitter coil may be arranged on the mobile device, and the charging receiver coil may be arranged on the wireless charging device. Rearranging the above embodiments accordingly will be obvious to those skilled in the art. According to an alternative embodiment of the present invention, the mobile device may include the docking control device. Accordingly, the method according to the invention is then carried out by the mobile device. The mobile device may include any device with a battery that may be charged wirelessly, such as a cell phone, mobile robot, or vehicle. Sampling the power transmission may be done indirectly by detecting a battery charge level.

According to the present invention, the feedback may include user feedback or machine-to-machine feedback. Many other examples or adaptations of the above embodiments will be apparent to those skilled in the art upon reviewing the above description without departing from the scope of the invention.

Each of the following claims is incorporated herein as a separate preferred embodiment. Certain features of the disclosed embodiments are shown on an exaggerated scale or schematically, and some details of conventional elements are omitted for clarity and brevity. The word “a/an” in this description appropriately means “one or more” or “at least one”. The term “based on a value” may mean “using at least part of the value or a derivative or a derivation of the value”. The term “generate” includes “computing” by processing or executing corresponding instructions. The preferred embodiments of the invention have been described in the drawings and the description of the preferred embodiments. While these disclosures directly describe the above embodiments, it will be understood that modifications and/or variations to the particular embodiments shown and described herein may be contemplated by those skilled in the art. Any such changes or variations that fall within the scope of this disclosure are intended to be incorporated herein. Unless expressly stated, it is the inventor's intention to give words and phrases in the specification and claims their ordinary and customary meaning to those of ordinary skill in the relevant art. The above description of the preferred embodiments and best modes of the invention known to applicant at the time of filing is presented and is presented for illustrative purposes. Many modifications and variations are possible in light of the above teachings. Embodiments have been selected and described to best illustrate the principles and practice of the invention and to enable those skilled in the art to make optimal use of the invention in various embodiments and with various modifications as are suitable for the particular use contemplated.

1. A wireless charging device, comprising a first transmission circuit which has at least a first transmitter coil for transmitting wireless power, and a second transmission circuit which has at least one second transmitter coil for transmitting wireless power having, wherein the first transmission circuit is arranged so that it may be connected to a first power unit via a first power line in order to be supplied with power by the first power unit, and the second transmission circuit is arranged so that it may be connected to a second power unit via a second power line in order to be supplied with power by the second power unit.

2. The wireless charging device according to claim 1, wherein the first power line comprises a first connector for coupling to the first power unit and the second power line comprises a second connector for coupling the second power unit.

3. The wireless charging device according to claim 1, wherein the first transmitter coil and the second transmitter coil are arranged between a cover structure and a common shield, wherein the common shield includes a ferrite shield.

4. The wireless charging device according to claim 1, wherein the first transmission circuit comprises a first transmission circuit control for controlling the power supply to the first transmitter coil, and the second transmission circuit comprises a second transmission circuit controller for controlling the power supply to the second transmitter coil.

5. The wireless charging device according to claim 1, wherein the wireless charging device comprises a detection unit which is arranged to detect a physical feature of the first transmission circuit and the second transmission circuit, respectively or the control device, and that it provides the control device with detection data based on the detected physical feature; wherein:
the detection unit comprises at least one measuring circuit with a sensor module, and/or
the control device is adapted to selectively electrically couple and disconnect the first power line or the second power line based on detection data, and/or the control device is designed to control the first power circuit or the second power circuit based on detection data.

6. The wireless charging device according to claim 1, wherein the wireless charging device comprises a control device arranged configured such that that it controls the first transmission circuit and the second transmission circuit, in which the first transmission circuit or the second transmission circuit are supplied with power, wherein:
the wireless charging device comprises a first electrical switch arranged to be controlled by the control device to close the second power line to enable power transmission, and to open to stop power transmission; and/or
the wireless charging device comprises a second electrical switch arranged to be controlled by the control device to close and open the first power line to enable power transmission to stop the power transmission.

7. The wireless charging device according to claim 1, wherein the first transmitter coil and the second transmitter coil are arranged such that a first magnetic field generated by the first transmitter coil may at least partially superimpose or may substantially completely or congruently superimpose a second magnetic field generated by the second transmitter coil, when the first transmitter coil and the second transmitter coil are supplied with power, wherein:
the first transmitter coil and the second transmitter coil may be arranged axially at least partially substantially one on top of the other or one above the other, and/or
the first transmitter coil and the second transmitter coil may be arranged obliquely to one another, and/or
the wireless charging device has a housing which accommodates at least one of the first transmission circuit, the second transmission circuit and the control device, and/or
at least one of the first transmitter coil, the second transmitter coil and the control device may be mobile or arranged outside a housing accommodating at least one of the first transmission circuit, the second transmission circuit and the control device.

8. The wireless charging device according to claim 1, wherein the detection unit is arranged to detect a power transmission between the wireless power transmission device and the wireless charging device, wherein the control device is designed to output feedback when a wireless power transmission takes place between the wireless charging device and the wireless power transmission device, wherein the control device is further designed to update and output the feedback during the power transmission between the wireless charging device and the wireless power transmission device based on at least one power transmission rate of the wireless power transmission for optimal alignment of the mobile device with respect to the wireless charging device.

9. A computer program product that includes instructions that, when executed by a processor, cause the processor to perform the following steps:
detecting a power transmission by a detection unit,
receiving a signal sent by the detection unit regarding the detected power transmission,
generating a power transmission rate with respect to the detected power transmission using the signal received from the detection unit,
outputting feedback during power transmission based at least on the power transmission rate,
further detecting of the power transmission,
receiving the signal sent by the detection unit regarding the further detected power transmission,
generating a further power transmission rate with respect to the further detected power transmission using the signal received from the detection unit,
updating and outputting the feedback during power transmission based on at least the further power transmission rate.

10. A method comprising the following steps:
providing a wireless charging device comprising a first transmission circuit which has at least a first transmitter coil for transmitting wireless power, and a second transmission circuit which has at least one second transmitter coil for transmitting wireless power having, wherein the first transmission circuit is arranged so that it may be connected to a first power unit via a first power line in order to be supplied with power by the first power unit, and the second transmission circuit is arranged so that it may be connected to a second power unit via a second power line in order to be supplied with power by the second power unit,
detecting a power transmission,
receiving a signal sent regarding the detected power transmission,
generating a power transmission rate with respect to the detected power transmission using the received signal,
outputting feedback during power transmission based at least on the power transmission rate,
further detecting of the power transmission,
receiving the signal sent with respect to the further detected power transmission,
generating a further power transmission rate with respect to the further detected power transmission using the received signal,
updating and outputting the feedback during power transmission based on at least the further power transmission rate.
